(19) United States
(12) Patent Application Publication
(10) Pub. No.: US 2010/0062741 A1
(43) Pub. Date: Mar. 11, 2010

(54) EMERGENCY MESSAGE SERVICE METHOD AND APPARATUS FOR MOBILE TERMINAL

(75) Inventors: Shin Duck LEE, Gyeongsangbuk-do (KR); Jong Phil Lee, Daegu Metropolitan City (KR)

Correspondence Address: CHA & REITER, LLC, 210 ROUTE 4 EAST STE 103, PARAMUS, NJ, 07652, US

(73) Assignee: Samsung Electronics Co., LTD., Gyeonggi-Do (KR)

(21) Appl. No.: 12/555,058

(22) Filed: Sep. 8, 2009

(30) Foreign Application Priority Data
Sep. 9, 2008 (KR) 2008-88713

(51) Int. Cl. H04M 11/04; H04M 1/00

(52) U.S. Cl. 455/404.1; 455/550.1

(57) ABSTRACT

An emergency message service method and apparatus for a mobile terminal in which the emergency message service can be effectively utilized even when call forwarding is active in the mobile terminal. The detection and deactivation of call forwarding for an emergency message permits an emergency call to be rapidly established. The emergency message service method may include: checking, upon detection of an emergency message request, the setting status of call forwarding; deactivating, when call forwarding is active, call forwarding; sending, after deactivation of call forwarding, a requested emergency message using a pre-enrolled subscriber number.

### CLAIM OF PRIORITY

This application claims priority from an application entitled “EMERGENCY MESSAGE SERVICE METHOD AND APPARATUS FOR MOBILE TERMINAL” filed in the Korean Intellectual Property Office on Sep. 9, 2008 and assigned Serial No. 10-2008-0088713, the contents of which are incorporated herein by reference in its entirety.

### BACKGROUND OF THE INVENTION

1. Field of the Invention

The present invention relates generally to an emergency message service and, more particularly, to an emergency message service method and apparatus for a mobile terminal.

2. Description of the Related Art

In recent years, mobile terminals have provided an ever-increasing variety of functions designed to meet diversified user requirements. For example, advanced mobile terminals provide functions related to mail, access to the Internet, gaming, and transmission of multimedia including data and images.

A mobile terminal periodically communicates with a base station covering a specific area so as to provide location information for call establishment. As the user carrying the mobile terminal travels by vehicle or on foot, the mobile terminal is handed over from one base station to another base station.

In the case of emergency situations, such as car accidents or getting lost in the mountains, the user carrying a mobile terminal may have to make a call to a police station or a relief squad to report such a situation. However, the user may be pressed for time to immediately place a call. Therefore, an emergency reporting function is added to a mobile terminal. In other words, using the emergency reporting function, the user can immediately send an emergency message (also known as an SOS message) to a pre-enrolled recipient number to notify another person of the emergency situation. Then, the user of the recipient mobile terminal receiving the emergency message can make a call for relief to the mobile terminal having sent the emergency message on the basis of the phone number attached to the emergency message.

A call forwarding service enables a subscriber to forward incoming calls addressed to the called subscriber to another pre-registered subscriber number. Examples of the call forwarding service may include “call forwarding busy” (CFB), “call forwarding no answer” (CFNA), and “call forwarding unconditional” (CFU).

More particularly, when the user of a mobile terminal activates a call forwarding function after registering (designating) a forward-to number, incoming calls addressed to the mobile terminal from other users are automatically sent to the pre-registered forward-to number.

In the case of an emergency, the user of a mobile terminal having call forwarding activated sends an emergency message to a pre-enrolled recipient number. Upon reception of the emergency message, the user of the recipient mobile terminal makes a call using the phone number attached to the emergency message. However, as call forwarding is activated in the mobile terminal having sent the emergency message, the call made by the recipient user may be directed to a pre-registered forward-to number (not to the emergency reporting user).

As described above, in the case of an emergency, a call forwarding service used in a mobile terminal may result in a failure to establish a call for emergency assistance. Namely, activation of CFU in a mobile terminal may block effective use of the emergency message service.

### SUMMARY OF THE INVENTION

The present invention provides for an effective use of the emergency message service in a mobile terminal.

The present invention also provides an emergency message service method and apparatus for a mobile terminal wherein the emergency message service is effectively utilized when call forwarding is activated in the mobile terminal.

The present invention further provides an emergency message service method and apparatus for a mobile terminal wherein when an emergency message request is issued while call forwarding is active in a recipient user, an emergency message is sent after call forwarding is automatically deactivated so that an incoming call can be rapidly established during an emergency situation.

In accordance with an exemplary embodiment of the present invention, there is provided an emergency message service method for a mobile terminal, including: checking a status of the mobile terminal, upon detection of an emergency message request, as to whether call forwarding has been set; deactivating call forwarding, when call forwarding has been set; sending, after deactivation of call forwarding, a requested emergency message using a pre-enrolled subscriber number.

In accordance with another exemplary embodiment of the present invention, there is provided an emergency message service method including: sending, by a mobile terminal, upon detection of an emergency message request during a status in which call forwarding is active, a deactivation request message for call forwarding to a serving base station; deactivating call forwarding, upon reception of the deactivation request message by the base station, and sending a deactivation response message to the mobile terminal; and sending, upon reception of the deactivation response message by the mobile terminal, a requested emergency message using a pre-enrolled subscriber number.

In accordance with another exemplary embodiment of the present invention, there is provided a mobile terminal including: a radio frequency unit for establishing a communication channel to a base station for communication, and for sending and receiving messages related to call forwarding and emergency messaging; an input unit for accepting a signal for an emergency message request, and for accepting a signal for activating and deactivating call forwarding; a memory unit for storing an application for handling operations related to emergency messaging, and for storing setting information related to call forwarding and emergency messaging; and a control unit for sending, upon detection of an emergency message request in a state where call forwarding is active, an emergency message after deactivating call forwarding.

In an exemplary aspect of the present invention, when an emergency message request is issued while call forwarding is active in a mobile terminal, an emergency message is sent subsequent to call forwarding being automatically deactivated. Hence, in an emergency situation, an incoming call to the mobile terminal for helping the user can be rapidly established.

### BRIEF DESCRIPTION OF THE DRAWINGS

The features and advantages of the present invention will be more apparent from the following detailed description in conjunction with the accompanying drawings, in which:

FIG. 1 is a flow chart of an emergency message service method in a state where call forwarding is activated according to an exemplary embodiment of the present invention;

FIG. 2 is a sequence diagram illustrating steps of the emergency message service method of FIG. 1;

FIG. 3 is a block diagram illustrating a mobile terminal according to another exemplary embodiment of the present invention; and

FIG. 4 is a flow chart illustrating a procedure of reactivating call forwarding after automatic deactivation thereof.

### DETAILED DESCRIPTION

Hereinafter, exemplary embodiments of the present invention are described in detail with reference to the accompanying drawings. The same reference symbols are used throughout the drawings to refer to the same or similar parts. Detailed descriptions of well-known functions and structures incorporated herein may be omitted to avoid obscuring appreciation of the subject matter of the present invention by a person of ordinary skill in the art.

The present invention relates to a method and apparatus for a supplementary service in a mobile terminal. In particular, when an emergency message request is issued while call forwarding is active in the mobile terminal, an emergency message is subsequent to the automatic deactivation of call forwarding, so that an incoming call from the counterpart subscriber can be rapidly established in an emergency situation. This automatic deactivation of call forwarding enables the counterpart subscriber to rapidly identify the emergency situation and provide or direct help to the user having sent the emergency message.

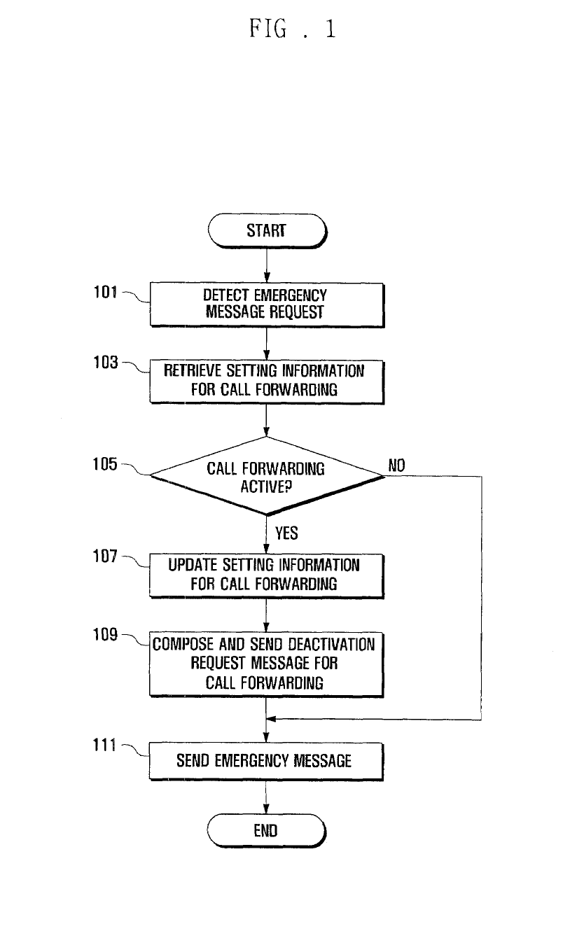

FIG. 1 is a flow chart of an emergency message service method while call forwarding is activated in a mobile terminal according to an exemplary embodiment of the present invention.

Referring now to FIG. 1, when an emergency message request is detected (101), the mobile terminal retrieves setting information related to a call forwarding service (103) and checks whether call forwarding is active (105).

In an emergency, the user may issue an emergency message request to notify of the emergency in a rather uncomplicated and direct fashion, such as, for example, by actuating a particular key of the mobile terminal.

The call forwarding service may be set in advance according to a user request through a preset signaling procedure with a corresponding base station. As procedures related to conventional call forwarding are known in the art, a description thereof is omitted. The assumption that the mobile terminal can make use of a conventional call forwarding service through a known signaling procedure will suffice as background information for the purpose of understanding the heretofore unknown description of the present invention. When a call forwarding service is set, the mobile terminal may store setting information related to the call forwarding service. The setting information may include, for example, a forwarding status indication indicating activation or deactivation of call forwarding, and a forward-to telephone number.

Referring back to FIG. 1, at step 101 upon detection of an emergency message request from the user, the mobile terminal, in this example, at step 103 retrieves the setting information related to a call forwarding service, so as to determine at step 105 whether or not call forwarding is currently active.

When call forwarding is inactive at step 105, the mobile terminal sends an emergency message using at least one forward-to telephone number provided in advance (step 111).

However, when call forwarding is active, the mobile terminal updates the setting information for call forwarding status indication in the setting information to ‘deactivated’ (107), and deactivates the call forwarding service by composing a request message for call forwarding deactivation and sending the deactivation request message to the corresponding base station (109). Here, a person of ordinary skill in the art should appreciate that according to the present invention step 107 (setting information update) and step 109 (deactivation request message transmission) may be performed at the same time, or it may be preferable that the steps are sequential, such as step 107 may be performed after step 109.

After deactivation of the call forwarding service, the mobile terminal sends an emergency message using at least one forward-to telephone number given in advance (111).

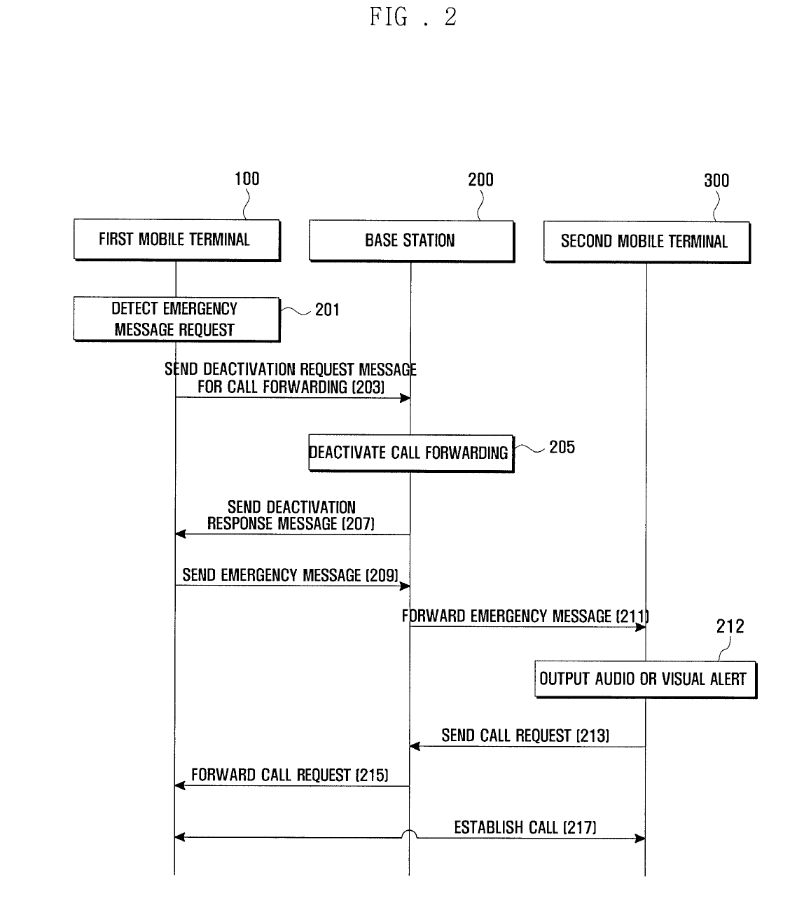

FIG. 2 is a sequence diagram illustrating exemplary steps of the emergency message service method of FIG. 1 according to the present invention.

In FIG. 2, in an overview, a first mobile terminal 100 sends, upon detection of an emergency message request during a status of the mobile terminal in which call forwarding is active, an emergency message to a counterpart mobile terminal whose telephone number is pre-stored for use in the event of an emergency situation. A second mobile terminal 300 receives the emergency message from the first mobile terminal 100, and makes a call to the first mobile terminal 100 as a reply to the emergency message. That is, the second mobile terminal 300 may be a counterpart mobile terminal whose telephone number is pre-stored in the first mobile terminal 100. The second mobile terminal 300 may be a terminal that is configured in accordance with the principles of the present invention, or a terminal having an ordinary configuration. A base station 200 establishes a communication channel to the first mobile terminal 100 and to the second mobile terminal 300 in a preset manner for communication services. In particular, the base station 200 sends and receives a signal related to a call forwarding service to and from the first mobile terminal 100, and activates and deactivates the call forwarding service for the first mobile terminal 100. The base station 200 also preferably relays an emergency message from the first mobile terminal 100 to the second mobile terminal 300, and relays a call request from the second mobile terminal 300 to the first mobile terminal 100 to establish a call corresponding to the emergency message.

Referring now to FIG. 2, when the first mobile terminal 100 detects an emergency message request in a state where call forwarding is active (201), first mobile terminal 100 composes a (or retrieves a pre-composed) request message for deactivation of call forwarding. First mobile terminal 100 sends the deactivation request message to the base station 200 (203).

At (205), upon reception of the deactivation request message from the first mobile terminal 100, the base station 200 deactivates the call forwarding service provided to the first mobile terminal 100. At (207), the base station 200 sends a deactivation response message to the first mobile terminal 100.

At (209), upon reception of the deactivation response message, the first mobile terminal 100 sends an emergency message to the base station 200 (209).

At (211), upon reception of the emergency message, the base station 200 then forwards the emergency message using at least one recipient phone number attached to the emergency message. In FIG. 2, the mobile terminal associated with the recipient phone number is the second mobile terminal 300. Hence, in this particular example, the base station 200 delivers the emergency message to the second mobile terminal 300 at step 211.

Upon reception of the emergency message, the second mobile terminal 300 at (212) outputs an audio or visual alert for message reception through a speaker or display unit so that the owner and/or others within close proximity to the second mobile terminal 300 while notice the alert. In response to the audio or visual alert for the emergency message, the user of the second mobile terminal 300 places a call to the first mobile terminal 100 using a phone number attached to the emergency message via the base station 200 (213). That is, the second mobile terminal 300 sends a call request to the base station 200 to contact the first mobile terminal 100.

At (215), in response to the call request from the second mobile terminal 300, the base station 200 forwards the call request to the first mobile terminal 100.

At (217), when the user of the first mobile terminal 100 accepts the call request, the call is established between the first mobile terminal 100 and second mobile terminal 300. By way of the aforementioned example, a conversation can be had as part of the emergency message service. Applicant respectfully submits that the presently claimed invention is not limited to the aforementioned example shown and described.

Signaling procedures related to emergency message transmission and call processing between the first mobile terminal 100, base station 200 and second mobile terminal 300 are known in the art, and a description thereof is omitted so an not to obscure appreciation by an artisan of the novel and non-obvious aspects of the presently claimed invention. However, the subject matter of the present invention is preferably related to a scheme that, when an emergency message request is issued in a state where call forwarding is active, the mobile terminal deactivates call forwarding first and sends an emergency message to allow normal arrival of an incoming call. Hence, the present invention is not limited by the conventional signaling procedures related to emergency message transmission and call processing.

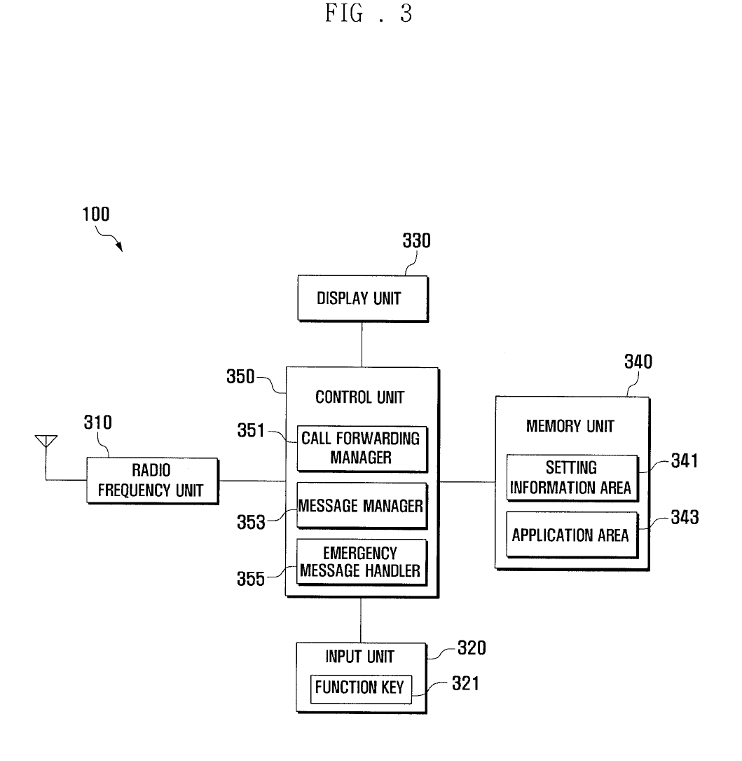

FIG. 3 is a block diagram illustrating a mobile terminal 100 according to another exemplary embodiment of the present invention.

Referring now to FIG. 3, the mobile terminal 100 preferably includes a radio frequency unit 310, input unit 320, display unit 330, memory unit 340, and control unit 350.

The radio frequency unit 310 performs communication operations for the mobile terminal 100, and establishes a communication channel for voice and data communication to a mobile communication network including a base station. The radio frequency unit 310 may include, for example, a radio frequency transmitter for upconverting the frequency of a signal to be transmitted and amplifying the signal, and a radio frequency receiver for low-noise amplifying a received signal and downconverting the frequency of the received signal. In particular, under the control of the control unit 350, the radio frequency unit 310 sends and receives a message related to the call forwarding service, and sends and receives a message related to the emergency message service.

The input unit 320 typically receives various alphanumeric information, and sends input key signals for setting and controlling various functions of the mobile terminal 100 to the control unit 350. The input unit 320 may include one or a combination of a touch pad, regular keypad, and a QWERTY keypad (or even a Dvorak keypad). The input unit 320 may include direction keys mapped to particular functions, and function keys such as a volume key and short cut key. In particular, the input unit 320 includes a function key 321 for initiating an emergency message service, and the user can issue an emergency message request using the function key. The input unit 320 receives an input signal for setting, activating and deactivating a call forwarding service.

Still referring to FIG. 3, the display unit 330 displays screen data generated by the operation of the mobile terminal 100, key manipulation data, function setting information, and signal and color data from the control unit 350. The display unit 330 may include any type of thin display, including but in no way limited to a panel of liquid crystal display (LCD) devices, an LCD controller for controlling LCD devices, and a video memory for storing video data. The panel may have a touch screen capability, in which case the display unit 330 may act as an input means.

The memory unit 340 may include a read only memory (ROM) and random access memory (RAM). In particular, the memory unit 340 stores setting information related to call forwarding and emergency messaging. The memory unit 340 stores temporary data generated by the control unit 350, and user data including telephone numbers and ring tones. The memory unit 340 may store applications for normal operations of the mobile terminal 100, and applications for emergency messaging of the present invention.

The emergency messaging applications may include a procedure for handling functions related to emergency messaging, a procedure for handling functions related to call forwarding, a procedure for checking the setting state of call forwarding upon detection of an emergency message request, a procedure for deactivating call forwarding depending on the setting state, and a procedure for sending an emergency message using a preset phone number after deactivation of call forwarding. The procedure for deactivating call forwarding may generate a pre-assigned code for call forwarding deactivation, and send a deactivation request message containing the generated code to the base station. The pre-assigned code may be a supplementary service (SS) code such as “##21#” denoting a command for call forwarding deactivation.

Still referring to FIG. 3, the memory unit 340 may include one or more buffers to temporally store various data generated from execution of the applications. The memory unit 340 may include, for example, a setting information area 341 for storing various setting information, and an application area 343 for storing various applications. The memory unit 340 may be composed of one or both of an internal storage medium and a separate external storage medium like a smart card.

The control unit 350 preferably controls the overall operation of the mobile terminal 100 and signal exchange between internal components thereof. That is, the control unit 350 controls signal exchange between the radio frequency unit 310, input unit 320, display unit 330, and memory unit 340. The control unit 350 may include, for example, a data processor composed of a codec and at least one modem for mobile communication services.

In particular, the control unit 350 preferably checks the setting state of call forwarding upon detection of an emergency message request, and performs operations related to emergency messaging according to the setting state. The control unit 350 can determine whether call forwarding is active or inactive by examining the setting information related to call forwarding. The control unit 350 may pre-store the setting information in the memory unit 340 when a call forwarding service is registered at the base station. The setting information may include a forwarding status indication and a forward-to telephone number. Thus, the control unit 350 can be aware of whether call forwarding is active or inactive by examining the forwarding status indication.

The control unit 350 may update or remove the setting information in the memory unit 340 when the call forwarding service is deregistered at the base station. Thus, the control unit 350 may determine whether call forwarding is active or inactive by detecting the presence of the setting information related to call forwarding. That is, the presence of the setting information may indicate activation of call forwarding, and the absence thereof may indicate deactivation of call forwarding.

In response to detection of an emergency message request while call forwarding is inactive, the control unit 350 composes or retrieves a previously-composed emergency message and sends the emergency message to at least one pre-enrolled mobile terminal. In response to detection of an emergency message request while call forwarding is active, the control unit 350 performs a procedure for deactivating call forwarding, and composes an emergency message and sends the emergency message to at least one pre-enrolled mobile terminal after deactivation of call forwarding.

To perform control operations, the control unit 350 includes a call forwarding manager 351 for processing operations related to call forwarding, a message manager 353 for composing and transceiving messages related to call forwarding and emergency messaging, and an emergency message handler 355.

The call forwarding manager 351 sends and receives signals relate to call forwarding to and from the base station according to user requests, and updates the setting information in the setting information area 341 of the memory unit 340 according to activation and deactivation of call forwarding. Upon detection of an emergency message request, the call forwarding manager 351 examines the call forwarding status and outputs the examination result.

The message manager 353 composes messages related to call forwarding and emergency messaging. The message manager 353 composes a forwarding activation request message containing an activation code and a forward-to phone number to activate call forwarding, composes a forwarding deactivation request message containing a deactivation code to deactivate call forwarding, and composes a message related to emergency messaging.

The emergency message handler 355 sends an emergency message composed by the message manager 353 according to an emergency message request. Upon reception of an emergency message, the emergency message handler 355 outputs a preset sound or visual alert.

As described above, the mobile terminal of the present invention can perform adequate emergency messaging upon detection of an emergency message request even when call forwarding is active. Hence, in an emergency situation, the user can rapidly inform of the emergency situation, leading to enhancement of the safety level for the user of the mobile terminal.

The control unit 350 can perform the operations described above and described in connection with FIGS. 1, 2 and 4, and these operations may be carried out through software.

Although an exemplary configuration of the mobile terminal 100 is illustrated in FIG. 3, the present invention is not limited by such an exemplary configuration. That is, the mobile terminal 100 may further include instead of or in addition to the items shown, one or more of, for example, a camera module, electronic payment module, digital broadcast receiving module, short-range communication module, audio processing module and Internet access module, if necessary. As apparent to those skilled in the art, one of the components mentioned above may be removed or replaced by another component.

As described above, upon detection of an emergency message request in a state where call forwarding is active, the mobile terminal automatically deactivates call forwarding before sending an emergency message. Thereafter, when the operation related to emergency messaging is completed, the mobile terminal may reactivate call forwarding.

For example, when call forwarding is deactivated because of emergency messaging, the control unit 350 of the mobile terminal may record the reason for deactivation in the setting information related to call forwarding. Later, when the operation related to emergency messaging is completed, the mobile terminal can reactivate call forwarding on the basis of the setting information.

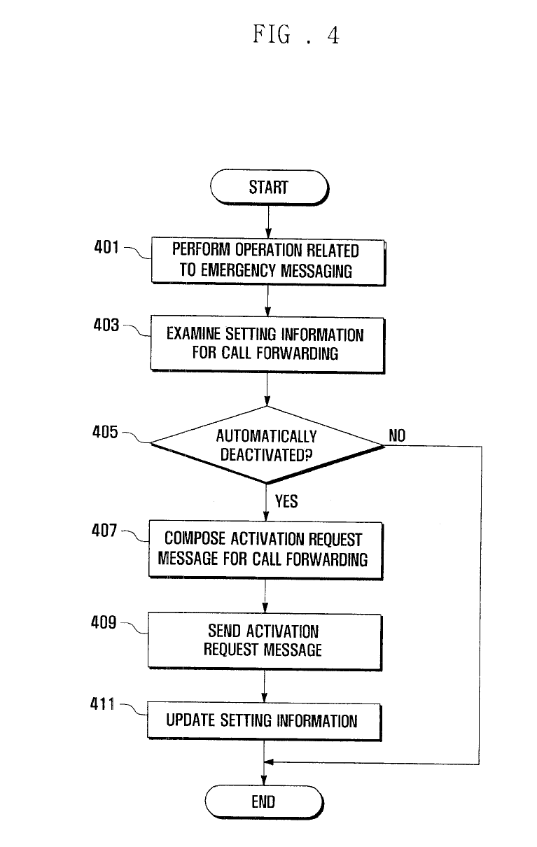

FIG. 4 is a flow chart illustrating an exemplary operational procedure of reactivating call forwarding after automatic deactivation thereof according to the present invention.

Referring now to FIG. 4, the mobile terminal performs the operation related to emergency messaging after call forwarding deactivation (401). Thereafter, the mobile terminal examines the setting information related to call forwarding (403). The setting information contains an indication of the call forwarding status and a reason for deactivation. This setting information may be set at initial service registration, and updated in the case of activation and deactivation.

The mobile terminal checks whether call forwarding has been automatically deactivated because of emergency messaging on the basis of the setting information (405).

When call forwarding has not been deactivated because of emergency messaging or no reason is present in the setting information, the mobile terminal terminates the procedure. When call forwarding has been deactivated because of emergency messaging, the mobile terminal composes an activation request message for call forwarding (407), and sends the activation request message to the serving base station (409). The mobile terminal may reactivate call forwarding through a signaling procedure with the base station.

After call forwarding reactivation, the mobile terminal updates the setting information (411). That is, the setting information is updated to indicate the reactivation of call forwarding. A person of ordinary skill in the art also understands that it is within the sprit and scope of the claimed invention that the reactivation does not have to be automatic, and or example, a prompt may issued by the mobile terminal asking the user whether it is desired to reactivate call forwarding.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. An emergency message service method for a mobile terminal, comprising:
detecting an emergency message request;
checking, in response to the emergency message request, the setting status of call forwarding;
deactivating call forwarding after determining from the setting status that call forwarding is active;
sending, after deactivation of call forwarding, a requested emergency message using at least one pre-enrolled subscriber number.

2. The emergency message service method of claim 1, wherein checking the setting status of call forwarding is performed by determine whether there is setting information stored by the mobile terminal at the time of registration of call forwarding.

3. The emergency message service method of claim 2, wherein deactivating call forwarding comprises performing a deactivation procedure for call forwarding with a serving base station, and updating the setting information to indicate call forwarding has been deactivated.

4. The emergency message service method of claim 1, further comprising automatically reactivating call forwarding when a procedure related to emergency messaging being substantially completed after emergency message transmission.

5. The emergency message service method of claim 1, wherein the mobile terminal prompts the user about whether or not to reactivate call forwarding.

6. An emergency message service method comprising:
sending a deactivation request message for call forwarding to a serving base station by a mobile terminal, upon detection of an emergency message request when said mobile terminal receives said emergency request message during a status in which call forwarding is active;
deactivating call forwarding by the serving base station, upon reception of the deactivation request message sent by the mobile terminal, and the serving base station sending a deactivation response message to the mobile terminal; and
sending by the mobile terminal a requested emergency message using a pre-enrolled subscriber number upon reception of the deactivation response message sent by the serving base station.

7. The emergency message service method of claim 6, wherein the mobile terminal automatically sends the deactivation message without determining whether call forwarding is active.

8. The emergency message service method of claim 6, further comprising the mobile terminal checking the setting status of call forwarding upon detection of the emergency message request.

9. The emergency message service method of claim 8, wherein checking the setting status of call forwarding is performed on a basis of setting information stored by the mobile terminal at the time of registration of call forwarding.

10. The emergency message service method of claim 9, further comprising updating the setting information to indicate call forwarding has been deactivated upon reception of the deactivation response message by the mobile terminal.

11. The emergency message service method of claim 6, further comprising the mobile terminal automatically reactivating call forwarding through a signaling procedure with the serving base station when a procedure related to emergency messaging is completed after emergency message transmission.

12. The emergency message service method of claim 6, wherein the deactivation request message contains a pre-assigned code for call forwarding deactivation.

13. A mobile terminal comprising:
a radio frequency unit for establishing a communication channel to a base station for communication, and for sending and receiving messages related to call forwarding and emergency messaging;
an input unit for accepting an input signal entered through the input unit of said mobile terminal for generating an emergency message request, and for accepting an input signal for activating and deactivating call forwarding;
a memory unit for storing an application for handling operations related to emergency messaging, and for storing setting information related to call forwarding and emergency messaging; and
a control unit for sending, upon detection of an emergency message request in a state where call forwarding is active, an emergency message after deactivating call forwarding.

14. The mobile terminal of claim 13, wherein the application comprises:
a procedure for checking a setting status of call forwarding upon detection of an emergency message request;
a procedure for deactivating call forwarding according to the setting status; and
a procedure for sending a requested emergency message to a pre-enrolled mobile terminal after deactivation of call forwarding.

15. The mobile terminal of claim 14, wherein the procedure for deactivating call forwarding composes a deactivation request message containing a pre-assigned code for call forwarding deactivation and wherein the deactivation request message is sent to the base station.

16. The mobile terminal of claim 13, wherein the control unit updates the setting information related to call forwarding stored in the memory unit in response to call forwarding being activated and deactivated.

17. The mobile terminal of claim 16, wherein the setting information is updated through a signaling procedure with the base station.

18. The mobile terminal of claim 16, wherein the control unit further comprises:
a call forwarding manager for sending and receiving signals related to call forwarding, for updating the setting information stored in the memory unit according to activation and deactivation of call forwarding, and for examining the call forwarding status upon detection of an emergency message request;
a message manager for composing an activation request message containing an activation code and a forward-to phone number to activate call forwarding, for composing a deactivation request message containing a deactivation code to deactivate call forwarding, and for composing a message related to emergency messaging; and
an emergency message handler for sending an emergency message in response to an emergency message request, and for outputting, upon reception of an incoming emergency message, a preset alert indicating the incoming emergency message.

19. The mobile terminal of claim 16, wherein the control unit reactivates call forwarding in accordance with a procedure related to emergency messaging being completed after an emergency message transmission.

20. The mobile terminal of claim 18, wherein the activation request message and deactivation request message are pre-stored in the memory unit and retrieved by the message manager for transmission.
